(19) United States
(12) Patent Application Publication
(10) Pub. No.: US 2007/0226995 A1
(43) Pub. Date: Oct. 4, 2007

(54) SYSTEM AND METHOD FOR ADHERING LARGE SEMICONDUCTOR APPLICATIONS TO PCB

(76) Inventor: Gregory Alan Bone, Santa Monica, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/693,531

(22) Filed: Mar. 29, 2007

Related U.S. Application Data
(60) Provisional application No. 60/788,227, filed on Mar. 30, 2006.

(51) Int. Cl. B32B 37/00

(52) U.S. Cl. 29/832; 29/840; 29/842; 156/256; 257/754; 257/758

(57) ABSTRACT

A system and method for reducing power losses in a semiconductor device, especially a photovoltaic cell. The system includes a semiconductor device that includes at least one conductive crossbar with a pattern and a substrate that includes similarly patterned supplemental crossbars. The crossbars are coated with the adhesive solder paste and superimposed on each other. The adhesive solder paste when heated forms a conductive path between the crossbars and the supplemental crossbars while simultaneously adhering the crossbars and the supplemental crossbars together. Thereafter an under-fill material is deposited into voids defined by gaps between the semiconductor device and the backplate.

### CROSS REFERENCE TO RELATED APPLICATION

This application claims priority of the filing date of Provisional Application Ser. No. 60/788,227 filed Mar. 30, 2006, the contents of which are incorporated by reference herein.

### BACKGROUND

1. Field of the invention

The invention relates to system and method for adhering large semiconductor system to printed circuit boards or other suitable substrates. More particularly the invention provides a system and method for adhering photovoltaic cells or processor chips to printed circuit boards.

2. Brief Discussion of Related Art

Illustrated in FIG. 1 is a plan view of a photovoltaic silicon wafer 100 including a silicon portion 102 and two separate semiconductor members arranged to support an electric field between associated conductive elements and electrical contacts. The silicon wafer 100 is adapted to directly transform sunlight into electrical energy using a p-n junction incorporated into the side of the wafer opposite the solar exposure. The p-n junction comprises p-type and n-type semiconductors applied to or incorporated into the silicon wafer 100 by doping the wafer with boron and phosphorous atoms, respectively.

The p-type semiconductor is coupled to and schematically represented by a first edge bar 110 and a first plurality of cross bars 112 spanning the wafer 100 or a region thereof. It should be noted that the first edge bar 110 and the first plurality of cross bars 112 are associated with the p-type semiconductor. These bars are also referred to, interchangeably, as traces. The first plurality of cross bars 112 includes a set of one or more intermediate cross bars 112, including two first cross bars 114 at the outer side edges of the wafer 100. Similarly, the n-type semiconductor is coupled to and schematically represented by a second edge bar 120 and a second set of cross bars 122 that are parallel to, and interdigitated with, the first plurality of cross bars 112, to create a sequentially alternating pattern of p-type and n-type semiconductors and associated conductive elements. Again, it should be noted that the second edge bar 120 and the first plurality of cross bars 112 are associated with the n-type semiconductor. These bars are also referred to, interchangeably, as traces. The first edge bar 110 serves to electrically couple the first plurality of cross bars 112, while the second edge bar 120 serves to electrically couple the second plurality of cross bars 122.

The wafer 100 may further include one or more conductive layers of metallization bonded to the p-type and n-type semiconductors to efficiently conduct the current collected by the wafer to electrical contacts coupled to other cells or an electrical load. The conductive layers, including copper and tin, are generally 60 milli-inches (mils) thick.

Photons of sufficient energy incident on the wafer 100 generally generate electron-hole pairs. The ejected electrons are drawn to the p-type semiconductor and collected by the cross bars 112, 114, which are associated with the p-type portion of the photovoltaic cell. In the same manner, the holes drawn to the n-type semiconductor and collected by the cross bars 122 associated with the n-type portion of the photovoltaic cell.

While solar cells may be formed from substantially whole wafers, some solar panels employ a plurality of smaller silicon dies cut from a wafer to increase its packing density, The dies may then be bonded to a substrate providing structural support and thermal conductivity using solder that forms a bond when heated to its reflow temperature. Solder paste may be applied in select regions to the bonding surface and the combination of die and substrate subjected to a solder reflow oven. The solder paste is generally a bismuth-tin-silver mixture with a melting temperature of approximately 140 degrees Celsius and a reflow temperature of 160 degrees Celsius, although alternative solder pastes may also be used.

### SUMMARY OF THE INVENTION

One embodiment of the present invention provides a method of applying under-fill material to a chip wherein the under-fill is forced through one or more vias in a substrate into one or more voids between the substrate and chip attached thereto. In some embodiments the force is based on external pressure, surface tension of the under-fill material, or a combination thereof. The means of attachment may include soldering, sintering, adhering with the aid of an adhesive or other technique. It is contemplated that whatever attachment mode is used, that it would include conductive components. In some embodiments the substrate is a printed circuit board. The chip, in one preferred embodiment is a photovoltaic cell, in another preferred embodiment the chip is a computer processor.

In another embodiment a solar power system is provided. The system includes a backing plate, under-fill material, a substantially planar substrate having a first surface and a second surface and including a plurality of vias, and a plurality of photovoltaic cells separated by gaps. In this embodiment each photovoltaic cell has a frontside and a backside. The backing plate is in substantial contact with under-fill material and the under-fill material is in substantial contact with the first and second surfaces of the substrate, and in substantial contact with the backside of the photovoltaic cells. A transparent cover, is provided over the photovoltaic cells, and the gaps separating the photovoltaic cells. The transparent cover is in substantial and continuous contact with the photovoltaic cells and acts as a barrier to prevent the under-fill from occluding the upper side of the photovoltaic cells. As the term is used here, transparent means passing significant portions of light in significant portions of the electromagnetic radiation spectrum from about 300 nm to 1,200 nm, and especially between 400 nm and 700 nm i.e. the visible region.

In another embodiment, a system for reducing power losses in a semiconductor device is provided. In this embodiment, the semiconductor device includes a plurality of conductive crossbars, the crossbars are arranged in a pattern. Further, a substrate including conductive supplemental crossbars having a pattern which is superimposible on the pattern of the plurality of crossbars is also provided. The crossbars and the supplemental crossbars are coated with an adhesive solder paste and then the crossbars superimposed on one another. The adhesive solder paste, when heated forms a conductive path between the crossbars and the supplemental crossbars while simultaneously adhering the crossbars and the supplemental crossbars together. Thereafter an under-fill material is deposited into voids defined by gaps between the semiconductor device and the backplate.

In one embodiment the adhesive solder paste includes conductive metal particles coated with at least one of the following metals, or an alloy of two or more of the following metals: tin, bismuth, lead, indium, and antimony. In one embodiment the particles are coated with tin and a solder flux. In some embodiments the flux is water soluble and has a low outgassing rate.

In some embodiments the conductive metal particles are selected from the group: copper, aluminum, silver, and gold. In one case the particles are copper, and when the adhesive solder paste is heated, the coated copper particles become metallurgically bound to one another. In some embodiments the adhesive solder paste is substantially lead free.

In another embodiment the adhesive solder paste includes at least on of the following adhesives: meltable plastics, urethanes, epoxies, thermosetting polymer resins, polyimide siloxane resin; styrene allyl alcohol resin; and phenoxy polymers. One of the embodiments of the present invention provides an adhesive between the crossbars and the supplemental crossbars such that the photovoltaic cell does not become materially deformed as a result of thermal expansion and contraction at temperatures up to 170° Celsius. In another embodiment the adhesive has an adhesive strength of at least three PSI prior to hardening.

In some embodiments the under-fill material is selected from the group including liquid-based elastomeric thermal conductors, strong bonding epoxy. In some embodiments the plurality of conductive supplemental crossbars augment the conductive capacity of the conductive crossbars. It is contemplated that the semiconductor device is a photovoltaic device, and the addition of the supplemental crossbars allows the photovoltaic cell to more efficiently deliver power to a battery or other application. This is especially so when the cell is exposed to focused sunlight, which oftentimes results in photovoltaic cells having significantly larger power outputs, which could result in undesirable losses but for the addition of the supplementary crossbars.

### BRIEF DESCRIPTION OF THE DRAWINGS

The present invention is illustrated by way of example and not limitation in the figures of the accompanying drawings, and in which:

FIG. 1 is a photovoltaic silicon wafer in accordance with the prior art;

FIG. 2 is a plan view of a substrate including a plurality of vias for applying under-fill to a photovoltaic cell, in accordance with the preferred embodiment of the present invention;

FIG. 3 is a cross section of a solar panel including a photovoltaic cell and substrate before being subjected to a solder reflow oven, in accordance with the preferred embodiment of the present invention;

FIG. 4 is a cross section of a solar panel including a photovoltaic cell and substrate after being subjected to a solder reflow oven, in accordance with the preferred embodiment of the present invention;

FIG. 5 is a cross section of a solar panel including a plurality of photovoltaic cells and substrate after being subjected to a solder reflow oven, in accordance with the preferred embodiment of the present invention; and

FIGS. 6A and 6B are cross sections of a solar panel assembly in a double chamber vacuum before and after a cover is applied, respectively, in accordance with the preferred embodiment.

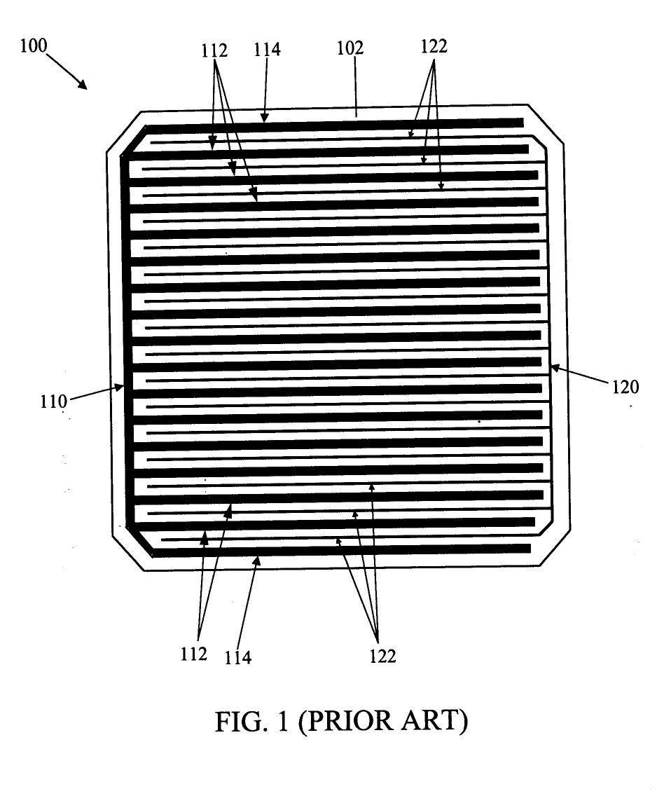

### DETAILED DESCRIPTION OF THE PREFERRED EMBODIMENT

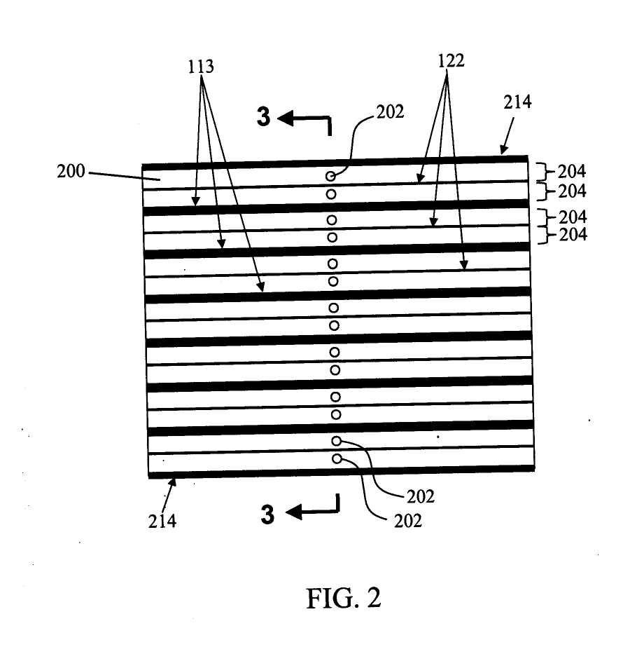

Illustrated in FIG. 2 is a plan view of a substrate 200 adapted to be bonded to a photovoltaic cell. The photovoltaic cell (not shown) is preferably a silicon photovoltaic cell wafer although a wide variety of other types of semiconductor chips may also be used with the substrate. The substrate 200 preferably includes a plurality of vias 202 for applying or otherwise transporting under-fill material to the cavities created between the cell and substrate, thereby inhibiting the ingress of water and other contaminants. As one skilled in the art will appreciate, the vias 202 employed with the current substrate 200 may also be used to apply under-fill to wafers, chips, or processors to circuit boards or heat sinks, for example.

A photovoltaic wafer is adapted to transform sunlight into electrical energy using a p-n junction incorporated into the same side of the wafer, i.e., the side opposite the solar exposure. Like the prior art wafer 100, the p-n junction includes a p-type semiconductor, n-type semiconductor, and associated conductive layers applied to or incorporated into the wafer. To augment the current-carrying capacity of the p-n junction, the substrate 200 includes a first and second set of supplemental cross bars that are electrically coupled to the corresponding conductive elements of the wafer. The first set of supplemental cross bars includes a first plurality of supplemental cross bars 113 mirroring the p-type cross bars 112 of the wafer 100, and a second plurality of supplemental cross bars 123 mirroring the one or more n-type cross bars 122 of the wafer 100. The supplemental cross bars 214 at either end (top and bottom as shown) may be approximately half the width of the first plurality of supplemental cross bars 113 as discussed in co-pending U.S. patent application Ser. No. 11/249,129 filed on Oct. 12, 2005 and hereby incorporated by reference herein for all that it discloses.

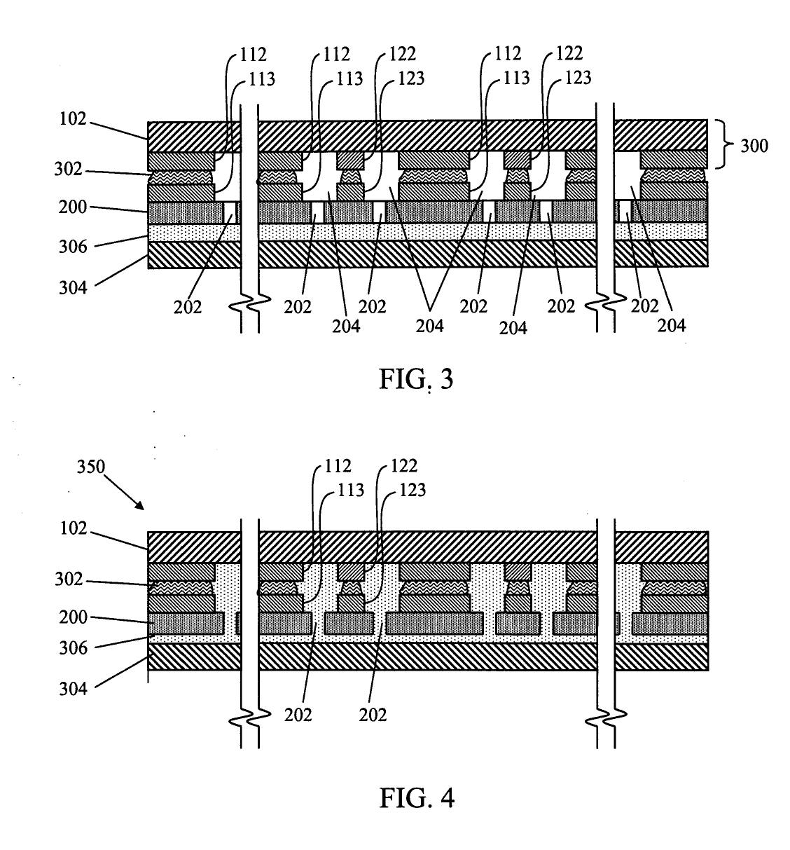

The substrate 200 includes a plurality of holes or vias 202, each via 202 providing a passage through which under-fill material may flow from the underside of the substrate to the region between the substrate 200 and photovoltaic cell (see FIG. 3) to which it is bonded. The substrate 200, in the preferred embodiment, includes at least one via 202 between each pair of adjacent conductive traces on the substrate 200, thereby allowing the under-fill material to seep into each of the long, narrow channels 204 (illustrated running left to right) created between the substrate 200 and photovoltaic cell when bonded together. A via 202 is preferably placed in proximity to the center point along the length of each the narrow channels 204 to facilitate the outward spread of the under-fill to the peripheral edges of the substrate 200. Two or more vias 202 per channel 204 may also be employed, although the contact boundary between portions of under-fill material from different Vias 202 may be structurally weaker than surrounding areas of under-fill.

Illustrated in FIG. 3 is a cross sectional view of the photovoltaic cell 300 bonded to the substrate 200 made of FR4 Glass Epoxy, polyimide film, Aluminum Nitride, or like material. The photovoltaic cell 300 includes a silicon portion 102 and conductive traces or cross bars 112, 122. The substrate 200 provides structural support to, and dissipates heat from, the photovoltaic cell 300. In addition, the substrate 200 in the first preferred embodiment also includes supplemental conductive crossbars that provide electrical conductivity to augment the limited conductivity of the conductive traces or cross bars 112, 122 of the photovoltaic cell 300, thereby minimizing the resistive losses—referred to as i²R losses—of the p-type and n-type semiconductors and corresponding conductive layers. As illustrated, the first plurality of supplemental cross bars 113 on the substrate and the first plurality of cross bars 112 of the photovoltaic cell 300 (associated with the p-type material) are brought into contact with solder paste 302. Similarly, the second plurality of supplemental cross bars 123 and the second plurality of cross bars 122 of the photovoltaic cell 300 (associated with the n-type material) are also brought into contact with solder paste 302. The solder paste 302 is characterized by a solder reflow temperature at which the solder melts and bonds the photovoltaic cell 300 and substrate 200 together. The solar panel in the preferred embodiment also includes a rigid backing plate 304 formed of aluminum, for example, with a layer of under-fill material 306 between it and the substrate 200. The backing plate 304 may serve as a heatsink in addition to providing structural support for one or more substrates 200.

The method of manufacturing the combination of photovoltaic cell 300, substrate 200, and backing plate 304 is a two step process in one exemplary embodiment. The combination of photovoltaic cell 300 and substrate 200 is first subjected to a solder reflow oven to bond the respective conductive traces of the photovoltaic cell 300 and substrate 200 together, i.e., conductive traces or cross bars 112 bond to supplemental traces or supplemental cross bars 113 and conductive traces or cross bars 122 bond to supplemental traces or cross bars 123. Thereafter, the combination is bonded to the backing plate 304 and an optional transparent cover, and under-fill applied.

In the preferred embodiment, the photovoltaic cell 300 and substrate 200 are bonded using a composite solder paste including an adhesive and one or more metallic components. In the preferred embodiment, the adhesive component, preferably epoxy, mechanically holds photovoltaic cell in place while the metallic component provide electrical conductivity. A suitable solder is manufactured by Kester, Inc. of Itasca, Ill. Due to the presence of the epoxy, the solder paste is adapted to act as an adhesive as the epoxy becomes partially cured. This adhesive force may be on the order of three or more psi. In one embodiment the adhesive force in the partially cured, pre-sintered adhesive is between 2 and 16 psi. Although specific values of about 4 psi, 5 psi, 6 psi, 7 psi, 8 psi, 9 psi and 10 psi are all acceptable. This phenomena is utilized in the preferred embodiment to adhere the photovoltaic cell 300 to the substrate 200 when subjected to the solder reflow oven, thereby inhibiting the heat-related curvature induced in the cell when subjected to the solder reflow oven. The curvature is primarily due to the differences in the coefficients of thermal expansion (CTE) between the different layers of the cell, which cause the cell to bow from side to side when viewed in cross section.

In one embodiment, the selected solder paste is InnovaBond™ TCM-20, a composite thermal interface material available from Kester in Itasca Ill. The solder paste has a storage temperature of approximately 40 degrees Celsius and a solder reflow temperature comparable to that of Bi Sn solder, although the actual reflow temperature varies depending on the alloy mixture. The solder is also relatively more flexible than tradition forms of solder. When applied in a layer of approximately 5 mils, the solder's elasticity and thickness enable it to withstand appreciable CTE mismatches between the photovoltaic cell 300 (or other chip) and substrate 200. The present invention is therefore highly suited to overcome problems with shearing and de-lamination associated with CTE mismatch in large semiconductor chip applications including processor chips.

In addition to providing an adhesive force that retards CTE induced photovoltaic cell deformations, the solder paste also provides electrical connectivity between the photovoltaic cell and the printed circuit board, namely between the cross bars (112, 122) and the supplemental cross bars (133, 123). In the preferred embodiment, the metallic component is a conductor made of sphere, balls, or other conductive particles. The conductive particles are comprised of conductive metal, where the term metal is explicitly understood to include alloys of metals. Importantly, in this embodiment, the conductive particles have a sintering temperature range that overlaps or encompasses the any required set temperature for the adhesive. As used herein, sintering between particles of a metal occurs when the metal or alloy particles are heated to temperatures sufficient to metallurgically bind them together. Sintering the metal particles in the adhesive results in the particles conductively joining to form a continuous connection between the traces on the photovoltaic cell and the contacts on the printed circuit board. In some embodiments the metal particle matrix may be anisotropic. If it is anisotropic, then no patterning is required when applying the material—and no underfill is necessary. In the more common embodiment, with isotropic conduction, the material can be screen printed to only connect appropriate portions of the circuit. The Innovabond material is in the isotropic class, and with it, an underfill process after the conductive assembly is indicated. The term anisotropic conductivity, as used herein refers to a configuration of conductive elements that produce non-uniform electrical conductivity, preferably conductivity in the direction perpendicular or substantially perpendicular to the circuit board surface with little or no conductivity in the plane parallel to the circuit board surface.

In another embodiment the particles of metal are heated to a temperature where the particles melt, coalesce and in this manner form a conductive link between the traces on the photovoltaic cell and the printed circuit board. An important element is that the adhesive must retain adhesion properties throughout the sintering or melting process. The continued adhesion is a means by which the present invention retards the effects of thermal expansion and deformation on the photovoltaic cell or other semiconductor application.

The conductive particles may be selected from a variety of materials however, the sintering temperature of the conductive particles must comport with the upper thermal limits tolerated by the electronic components or substrates being joined together. When using a thermoplastic polymer, the lower limit of the temperature range for the glass transition temperature must be above the temperature at which the printed circuit boards and electronic components or photovoltaic cell are tested after assembly or the temperature during actual use. Too low of a glass transition temperature may result in the unintended and unwanted adhesive flowing, resulting in a possible loss of at least some mechanical strength and potentially loss of electrical connection. U.S. Pat. No. 5,286,417, hereby incorporated for all that it discloses, provides an example of an electrically and mechanically acceptable composition. Similarly, U.S. Pat. No. 6,238,599 provides an electrically and mechanically suitable candidate. In some respects the coated copper sphere-like particles are very well suited to the present invention. The choice of the binder with the requisite mechanical properties can be readily identified by one of ordinary skill in the relevant art. The primary requirement is continued adhesion during the heating phase of the fabrication processing.

While InnovaBond from Kester is provided as an example, it is noteworthy that certain meltable plastics, urethanes and such could be used as the adhesive component. In some applications, it may be necessary to include a flux in the solder paste in order to “wet” the contacts and the conductive particles in the matrix and reduce the oxides from the surface of the metallics. The flux needs to be formulated to so as to not outgas (or outgas minimally) or be detrimental in other ways. Those of ordinary skill in the relevant art fully understand how to make epoxies that also act as reducing fluxes while they cure—for use as non-capillary under-fills in ball grid array packaging.

The method of using the adhesive-based solder paste preferably begins by elevating the temperature of the solder paste material above its storage temperature to initiate the curing process. In the present embodiment, this includes the steps of removing the solder paste from—40 cold storage, thus allowing the temperature of solder paste to rise using ambient air or an oven, for example, until it has reached approximately 25 degrees Celsius. The process continues by mounting the photovoltaic cell 300 to the substrate 200 using the solder paste 302 while the epoxy is substantially uncured, mechanically holding the cell and substrate together at approximately 25 degrees Celsius for a determined period of time until the epoxy has cured enough to exert an adhesive force substantially equal to or greater than the force of curvature of the cell when heated, and subjecting the combination of cell and substrate to the reflow oven to melt the solder paste and sinter the metallic components therein. As one skilled in the art will appreciate, the combination of photovoltaic cell 300 and substrate 200 must be brought to the solder reflow temperature in the oven before the epoxy has substantially cured so that the metallic components of the solder paste may melt and merge to form paths of electrical continuity through the solder. If the epoxy becomes substantially cured before reaching temperature in the oven, the epoxy matrix will be too rigid to permit the metal components of the solder to melt or metallurgically bind, potentially resulting in a metallic component that provides insufficient conductivity between the cell and substrate.

In a preferred embodiment, the solder paste is held at approximately 25 degrees Celsius for approximately one hour before reflowing. In some other embodiments, the solder paste is held at approximately 60 degrees C. for approximately 15 minutes. Of course, one skilled in the art will appreciate that the hold time may be increased or decreased depending on (a) the hold temperature, (b) the character of the solder paste itself, and (c) the force of curvature of the photovoltaic cell 300.

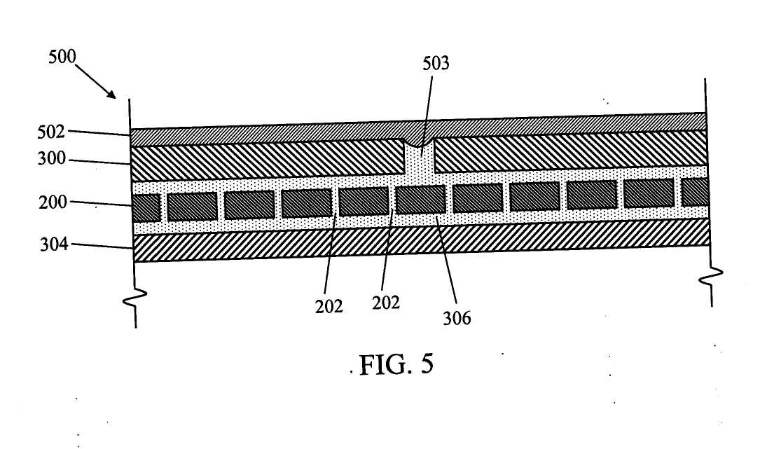

After the combination of photovoltaic cell 300 and substrate 200 are subjected to a first solder reflow oven and bonded, the backing plate 304, under-fill material 306, and optional cover (See FIG. 5) are applied in a second process flow. The under-fill material 306 is applied by silkscreen, for example, to the bottom surfaces of the substrate 200 and/or the backing plate 304. The combination of photovoltaic cell 300 and substrate 200 is placed on the aluminum backing 304 by a pick-and-place machine, for example, and the assembly made to adhere due to the viscosity of the under-fill material. The under-fill material 306 is preferably a liquid-based elastomeric thermal conductor, a strong bonding epoxy, or a material possessing a combination of these qualities. The under-fill 306 helps to prevent the ingress of water or other harmful contaminants in the channels 204 created between the patterned conductors etched from the photovoltaic cell 300 and substrate 200. The under-fill material 306 in the preferred embodiment is selected from a group of materials including SE4450 (available from Dow Corning) which is well known to those skilled as a thermal conductive adhesive but not an under-fill material.

When the assembly including the combination of photovoltaic cell 300 and substrate 200 with the, optionally, aluminum backing plate 304 is subjected to a second flow or reflow process, the under-fill is drawn up through the vias 202 by capillary action, pressure, or a combination thereof. The under-fill material is also drawn throughout the entire width of the channels 204 between conductive traces, as illustrated in the cross section of the solar panel 350 of FIG. 4 looking edge-wise on the channels 204. Since the under-fill is also a thermal adhesive, the second reflow process also bonds the backing plate 304 to the substrate 200. As one skilled in the art will appreciate, the preferred embodiment enables the under-fill to be incorporated into the photovoltaic cell at the time the aluminum backing plate 304 is bonded, thereby avoiding the need for a separate manual under-fill application step after the photovoltaic cell 300 and substrate 200 are soldered together.

In some embodiments, pressure is applied to compress the backing plate 304 against the combination of photovoltaic cell 300 and substrate 200 to enhance the distribution of under-fill material 306 through the vias 202 and channels 204. A pressure of two pounds per square inch (psi) may be sufficient although as much as 30 psi may be used to force under-fill material through the vias depending on the size of the vias and cavities as well as the viscosity and surface tension of the under-fill material.

While the process flow described above pertains to an assembly including a single cell, a similar process may be used to produce a solar panel including a plurality of photovoltaic cells or processor chips, for example. As illustrated in FIG. 5, the solar panel 500 preferably includes a substantially rigid, optionally aluminum, backing plate 304, a substrate 200 including a plurality of vias 202, a plurality of photovoltaic cells 300 separated by a gap 503, and a transparent cover 502. Between the substrate 200 and backing plate 304 is a layer of under-fill material 306 as described above. The transparent cover 502 protectively conceals the cells from adverse environmental conditions while acting as a barrier that stops under-fill from occluding the upper side of the photovoltaic cells 300. The transparent cover 502 in the preferred embodiment is ARLON (part no. 251888T017) available from Arlon Silicone Technologies Division of Bear, Del., although various other forms of elastic materials that are impermeable to the under-fill material may also be used.

In accordance with some embodiments, the under-fill 306 material may be incorporated into a solar panel with multiple photovoltaic cells in a single reflow process concurrent with the integration of the backing plate 304 and transparent cover 502. In particular, the backing plate 304, under-fill 306 and cover 502 are bonded to the photovoltaic cell 300 in a double vacuum laminator (DVL) in a continuous process including a single evacuation step after the photovoltaic cells 300 and substrate 200 are first electrically bonded in the first solder reflow process described above.

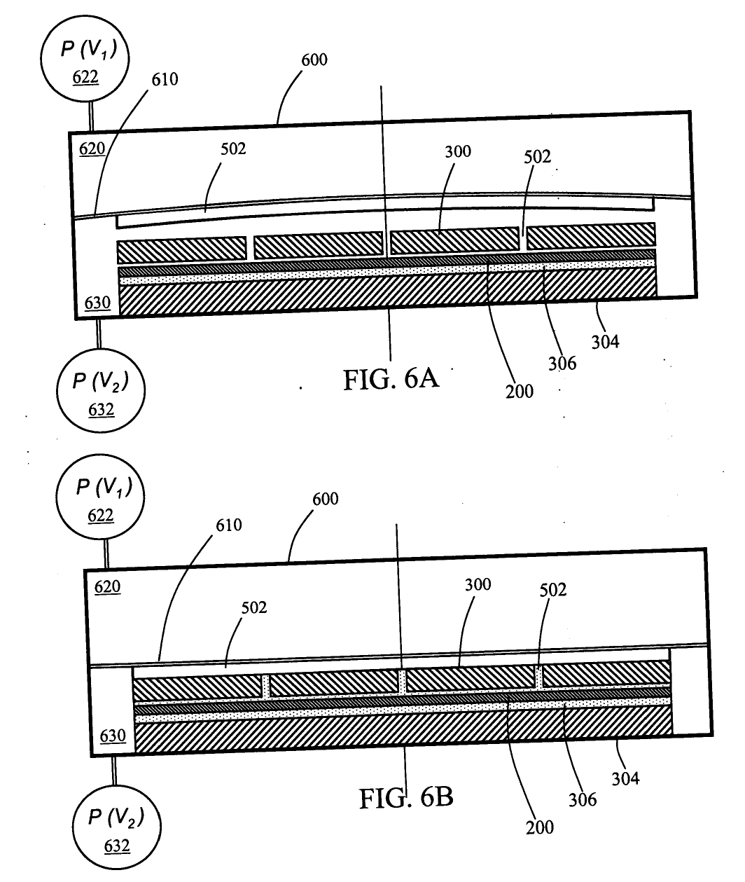

To begin, the thermal adhesive under-fill 306 is applied to the backing plate 304 using a silk screening process, for example. The substrate 200 with a plurality of photovoltaic cells 300 bonded thereto is assembled onto the backing plate 304 using a pick-and-place machine. The assembly of backing plate 304 with substrate and cells are chilled (at a temperature substantially below its flow temperature) in order to make the under-fill fixotropic. The chilled backing plate 304 and cover 502 are then placed in the DVL, which is well known to those skilled in the art. As illustrated in FIGS. 6A and 6B, a DVL 600 includes a first vacuum chamber 620 and a second vacuum chamber 630 separated by an elastic membrane 610. The pressure in the first vacuum chamber 620, P (V₁), is regulated by a first pump 622 for regulating the pressure, while the pressure in the second vacuum chamber 630, P (V₂), is regulated by a second pump 632. The elastic membrane 610 flexes in proportion to the pressure differential between the two vacuum chambers 620, 630.

The assembly of backing plate 304 and substrate 200 with plurality of photovoltaic cells 300 is placed in the second vacuum chamber 630. The layer of Arlon or other material constituting the cover the plurality of photovoltaic cells 300 is detachably attached to the elastic membrane using static charge, for example. The first and second vacuum chambers 620, 630 are pumped down in order to remove the air. An appropriate pressure differential between the first and second vacuum chambers is used to maintain the membrane 610 is a distended position above the photovoltaic cells 300. As illustrated in FIG. 6A, the Arlon is aligned with but held away from the photovoltaic cells 300 to prevent them from coming into contact prematurely.

While the under-fill 306 remains in the fixotropic state, both the first and second vacuum chambers are evacuated in a manner that keeps the Arlon 502 apart from the photovoltaic cells 300. With the air substantially evacuated from the second vacuum chamber 630, the pressure in the first vacuum chamber 620 is increased in order to lower the Arlon onto the plurality of photovoltaic cells 300 as illustrated in FIG. 6B. The pressure in the first chamber is selected to apply approximately 2 psi between the Arlon and backing plate 304. The pressure is sufficient to effectively seal the upper side of the photovoltaic cells 300, thus preventing any under-fill material from passing through the gaps between the photovoltaic cells 300 in the late stages of the lamination. Although the presence of under-fill material on the top of a processor is of little concern, under-fill on the upper surface of a photovoltaic cell would occlude sunlight and therefore make it unsuitable for solar applications. While Arlon is used to describe the properties of the transparent cover, this is merely one of many possible choices.

The temperature of the assembly including the under-fill 306 is raised to the flow temperature of the thermal adhesive. As its viscosity is reduced, the under-fill 306 material is drawn through the vias 202 to fill the interstitial spaces under and between the photovoltaic cells 300. As stated, the Arlon layer or cover 502 serves as a barrier that prevents the under-fill material from contaminating the upper side of the photovoltaic cells 300. If necessary, the under-fill material may be forcibly driven under and between the cells using a pressure of many atmospheres depending on the viscosity of the under-fill material. After the under-fill has penetrated the assembly of cells, the completed assembly is removed from DVL 600.

As one skilled in the art will appreciate, the process flow of the preferred embodiment permits (1) the backing plate 304 to be mounted to the substrate 200, (2) the under-fill 206 installed in the interstitial spaces of the assembly, and (3) the cover 502 to be mounted in a continuous process without the need to evacuate the chambers of the DVL 600 more than once, thereby reducing the processing time and expense.

Although the description above contains many specifications, these should not be construed as limiting the scope of the invention but as merely providing illustrations of some of the presently preferred embodiments of this invention.

Therefore, the invention has been disclosed by way of example and not limitation, and reference should be made to the following claims to determine the scope of the present invention.

What is claimed is:

1. A method of bonding a semiconductor device to a circuit board, the method comprising:
assembling the semiconductor device and circuit board with a solder paste selectively interposed between the semiconductor device and circuit board, wherein the solder paste comprises an adhesive and a plurality of conductive metal particles;
curing the solder paste sufficient to induce an adhesive force of at least 3 pounds per square inch; and
sintering the conductive metal particles before the adhesive solidifies to electrically connect the semiconductor device and circuit board.

2. The method of claim 1, wherein the semiconductor device is a photovoltaic cell.

3. The method of claim 1, wherein the semiconductor device is a computer processor.

4. The method of claim 1, wherein the circuit board is a printed circuit board.

5. The method of claim 1, wherein the adhesive comprises an epoxy.

6. The method of claim 1, wherein the adhesive is selected from the group comprising: a meltable plastic, a urethane, an epoxy, a thermosetting polymer resin, a polyimide siloxane resin, a styrene allyl alcohol resin, a phenoxy polymer, or a combination thereof.

7. The method of claim 1, wherein the plurality of conductive metal particles comprise copper core, tin alloy coated metal particles.

8. The method of claim 7, wherein the conductive metal particles comprise substantially spherical particles.

9. The method of claim 1, wherein the plurality of conductive metal particles comprise: copper; aluminum; silver; gold, or a combination thereof.

10. The method of claim 1, wherein the plurality of conductive metal particles are coated with an alloy of two or more of the following metals: tin, bismuth, lead, silver, gold, indium, and antimony.

11. The method of claim 1, wherein the conductive metal particles are coated with tin, and a solder flux.

12. The method of claim 1, wherein the solder paste adhesive force of at least 3 pounds per square inch exists prior to the sintering step.

13. A method of bonding a semiconductor device to a circuit board, the method comprising:
applying an adhesive solder paste to a semiconductor device or circuit board, wherein the adhesive solder paste comprises a plurality of conductive metal particles;
assembling the semiconductor device and circuit board;
heating the assembly of semiconductor device and circuit board sufficient to sinter the conductive metal particles to electrically connect the semiconductor device and circuit board.

14. The method of claim 13, wherein the adhesive solder paste comprises an epoxy.

15. The method of claim 14, wherein the method further comprises:
heating the epoxy to initiate curing prior to the step of applying the adhesive solder paste to the semiconductor device or circuit board.

16. The method of claim 15, wherein the semiconductor device is a photovoltaic cell, and the conductive metal in the adhesive solder paste is a plurality of substantially spherical particles coated with lead free-tin alloy.

17. The method of claim 16, wherein the adhesive has an adhesive force of at least 2 pounds per square inch prior to the heating step.
